(19) United States
(12) Patent Application Publication
(10) Pub. No.: US 2025/0223476 A1
(43) Pub. Date: Jul. 10, 2025

(54) MOISTURE-CURABLE ONE-COMPONENT ADHESIVE COMPOSITION

(71) Applicant: INOAC Technical Center Co., Ltd., Aichi (JP)

(72) Inventors: Yoshitaka ITOU, Kanagawa (JP); Atsushi MIYATA, Kanagawa (JP)

(21) Appl. No.: 18/850,116

(22) PCT Filed: Mar. 24, 2022
(86) PCT No.: PCT/JP2022/014072

§ 371 Date: Sep. 24, 2024

(51) Int. Cl. C09J 175/04

(52) U.S. Cl. CPC C09J 175/04

(57) ABSTRACT

Provided is a moisture-curable one-component adhesive composition having an excellent balance of both absorbency and adhesive strength. One aspect of the present invention is a moisture-curable one-component adhesive composition. The moisture-curable one-component adhesive composition contains a polyurethane prepolymer obtained by reacting a crystalline polyol and an amorphous polyol with a polyisocyanate, and a hydrophilicity imparting agent.

### FIELD OF THE INVENTION

The present invention relates to a moisture-curable one-component adhesive composition.

### BACKGROUND

In sanitary materials such as disposable diapers and napkins, hot melt adhesives are used for bonding substrates.

The hot melt adhesive is generally used mainly based on a styrene-based elastomer or an olefin-based resin and is also used for an absorbing portion such as a gather.

### SUMMARY OF THE INVENTION

### Technical Problem

Conventional hot melt adhesives have poor hydrophilicity of a base polymer. Therefore, absorption may be hindered at a bonding interface between members. Absorbency may be impaired particularly when used for members for sanitary products such as disposable diapers and incontinence pads, which require liquid permeation in a short time. In addition, when the conventional hot melt adhesive is used in the above-described applications, there is a problem that the adhesive strength is obtained to some extent, but absorbency is not sufficient. The present invention has been made in view of the above-mentioned problems, and an object of the present invention is to provide a moisture-curable one-component adhesive composition having an excellent balance of both absorbency and adhesive strength.

### Solution to Problem

One aspect of the present invention is a moisture-curable one-component adhesive composition. The moisture-curable one-component adhesive composition contains a polyurethane prepolymer (A) obtained by reacting a crystalline polyol (Aa) and an amorphous polyol (Ab) with a polyisocyanate (B), and a hydrophilicity imparting agent (C). In the moisture-curable one-component adhesive composition of the aspect, a contact angle obtained under the following contact angle evaluation conditions may be 60° or less. (Contact Angle Evaluation Conditions) The moisture-curable one-component adhesive composition is applied onto a glass plate and left to stand for 24 hours, and a contact angle between a cured resin and water is measured in accordance with JIS K6798:1999. In addition, the amorphous polyol (Ab) may include an amorphous polyol (Ab1) having a structural unit derived from an aliphatic dicarboxylic acid and/or an amorphous polyol (Ab2) having a structural unit derived from an aromatic dicarboxylic acid.

### Advantageous Effects of Invention

According to the present invention, it is possible to provide a technique relating to a moisture-curable one-component adhesive composition having an excellent balance of both absorbency and adhesive strength.

### DETAILED DESCRIPTION OF THE INVENTION

### Description of Embodiments

Hereinafter, embodiments of the present invention will be described in detail. Note that, in the present specification, the notation “a to b” in the description of the numerical range represents a or more and b or less, unless otherwise specified.

Hereinafter, a moisture-curable one-component adhesive composition according to an embodiment and a method for preparing the same will be described in detail according to the following items.
1. Moisture-Curable One-Component Adhesive Composition
1-1. Raw Materials
1-1-1. Polyurethane Prepolymer
1-1-1-1. Polyol
1-1-1-2. Polyisocyanate
1-1-2. Additives
1-1-2-1. Hydrophilicity Imparting Agent
1-1-2-2. Others
2. Method for Preparing Moisture-Curable One-Component Adhesive Composition
3. Applications of Moisture-Curable One-Component Adhesive Composition

### 1. Moisture-Curable One-Component Adhesive Composition

The moisture-curable one-component adhesive composition according to the present embodiment contains an isocyanate-terminated polyurethane prepolymer as a base resin. Further, if necessary, the adhesive composition may contain other components. When such a moisture-curable one-component adhesive composition is used, adhesiveness due to cooling and solidification of the polyurethane prepolymer in a molten state is exhibited, and further, an unreacted isocyanate terminal reacts with moisture in the air to form a three-dimensional crosslinked structure, thereby exhibiting stronger adhesiveness.

### 1-1. Raw Materials

### 1-1-1. Polyurethane Prepolymer

A stoichiometric excess of polyisocyanate is reacted with a polyol to obtain a polyurethane prepolymer.

A content of the polyurethane prepolymer is preferably 50 to 95 mass %, and more preferably 75 to 90 mass %, with respect to the entire composition.

### 1-1-1-1. Polyol

The polyol used in the present embodiment includes a crystalline polyol (Aa) and an amorphous polyol (Ab).

Examples of the crystalline polyol (Aa) include a crystalline polyester polyol, a crystalline polycarbonate polyol, and a crystalline polyether polyol. The crystalline polyol (Aa) may be used alone, or two or more kinds thereof may be used. Note that, when both a melting peak resulting from melting of the crystal structure of the polyol in a heating step and a crystallization peak resulting from reorientation (crystallization) of molecular chains in a cooling step are confirmed using a differential scanning calorimeter (DSC), the polyol is determined to have crystallinity. On the other hand, when at least one of the melting peak and the crystallization peak is not confirmed in the heating step, the polyol is determined to be amorphous.

Examples of the crystalline polyester polyol include polyester polyols obtained by a dehydration condensation reaction of an aliphatic dicarboxylic acid such as succinic acid, adipic acid, sebacic acid, dodecanedioic acid, or azelaic acid, an aromatic dicarboxylic acid such as phthalic acid, terephthalic acid, isophthalic acid, or naphthalenedicarboxylic acid, an alicyclic dicarboxylic acid such as hexahydrophthalic acid, hexahydroterephthalic acid, or hexahydroisophthalic acid, or an acid ester or acid anhydride thereof with ethylene glycol, 1,3-butanediol, 1,4-butanediol, 1,5-pentanediol, 1,6-hexanediol, or a mixture thereof.

Examples of the crystalline polycarbonate polyol include polycarbonate polyols obtained by reacting at least one polyhydric alcohol having 3 to 9 carbon atoms, such as 1,2-propylene glycol, 1,3-propylene glycol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol, or diethylene glycol, with diethylene carbonate, dimethyl carbonate, diethyl carbonate, or the like.

Examples of the amorphous polyol (Ab) include an amorphous polyester polyol, an amorphous polycarbonate polyol, and an amorphous polyether polyol. Examples of the amorphous polyester polyol include polyester polyols obtained by a dehydration condensation reaction of an aliphatic dicarboxylic acid such as succinic acid, adipic acid, sebacic acid, or azelaic acid, an aromatic dicarboxylic acid such as phthalic acid, terephthalic acid, isophthalic acid, or naphthalenedicarboxylic acid, an alicyclic dicarboxylic acid such as hexahydrophthalic acid, hexahydroterephthalic acid, or hexahydroisophthalic acid, or an acid ester or acid anhydride thereof with diethylene glycol, methylpropanediol, triethylene glycol, tetraethylene glycol, dipropylene glycol, tripropylene glycol, tetrapropylene glycol, thiodiethanol, neopentyl glycol, 1,4-cyclohexanedimethanol, or a mixture thereof.

Examples of the amorphous polycarbonate polyol include polycarbonate polyols obtained by reacting at least one polyhydric alcohol such as ethylene glycol with diethylene carbonate, dimethyl carbonate, diethyl carbonate, or the like.

Examples of the amorphous polyether polyol include polyethylene glycol, polypropylene glycol, and polytetramethylene ether glycol obtained by polymerizing cyclic ethers such as ethylene oxide, propylene oxide, and tetrahydrofuran, respectively, and a copolyether thereof. In addition, the amorphous polyether polyol can also be obtained by polymerizing the cyclic ether using a polyhydric alcohol such as glycerin or trimethylolethane.

The amorphous polyol (Ab) preferably includes any one of an amorphous polyol (Ab1) having a structural unit derived from an aliphatic dicarboxylic acid and an amorphous polyol (Ab2) having a structural unit derived from an aromatic dicarboxylic acid, and more preferably includes an amorphous polyol (Ab1) and an amorphous polyol (Ab2). By using the amorphous polyol (Ab1) and the amorphous polyol (Ab2) as the amorphous polyol (Ab), a more excellent balance of absorbency and adhesive strength can be exhibited. Examples of the amorphous polyol (Ab1) having a structural unit derived from an aliphatic dicarboxylic acid include polyester polyols obtained by a dehydration condensation reaction of succinic acid, adipic acid, sebacic acid, azelaic acid, or an acid ester or acid anhydride thereof with diethylene glycol, methylpropanediol, neopentyl glycol, 1,4-cyclohexanedimethanol, or a mixture thereof. Examples of the amorphous polyol (Ab2) having a structural unit derived from an aromatic dicarboxylic acid include polyester polyols obtained by a dehydration condensation reaction of phthalic acid, terephthalic acid, isophthalic acid, naphthalenedicarboxylic acid, or an acid ester or acid anhydride thereof with diethylene glycol, methylpropanediol, neopentyl glycol, 1,4-cyclohexanedimethanol, or a mixture thereof.

A mass ratio of the crystalline polyol (Aa) to the amorphous polyol (Ab) (mass of crystalline polyol (Aa)/mass of amorphous polyol (Ab)) is preferably 0.2 to 0.9, more preferably 0.25 to 0.85, and still more preferably 0.3 to 0.8. By setting the mass ratio of the crystalline polyol (Aa) to the amorphous polyol (Ab) within the above range, an excellent balance of absorbency and adhesive strength can be exhibited.

A number average molecular weight of each of the crystalline polyol (Aa) and the amorphous polyol (Ab) is preferably 300 to 10,000, more preferably 500 to 5,000, and still more preferably 1,000 to 3,000 in order to exhibit an excellent balance of absorbency and adhesive strength. Note that the number average molecular weight of each of the crystalline polyol (Aa) and the amorphous polyol (Ab) can be a numerical value measured by gel permeation chromatography and converted as a molecular weight of polystyrene, which is a standard sample.

### 1-1-1-2. Polyisocyanate

Examples of the polyisocyanate include, as bifunctional polyisocyanates, an aromatic polyisocyanate such as 2,4-toluene diisocyanate (2,4-TDI), 2,6-toluene diisocyanate (2,6-TDI), m-phenylene diisocyanate, p-phenylene diisocyanate, 4,4′-diphenylmethane diisocyanate (4,4′-MDI), 2,4′-diphenylmethane diisocyanate (2,4′-MDI), 2,2′-diphenylmethane diisocyanate (2,2′-MDI), hydrogenated MDI, xylylene diisocyanate, 3,3′-dimethyl-4,4′-biphenylene diisocyanate, 3,3′-dimethoxy-4,4′-biphenylene diisocyanate, polymethylene polyphenyl polyisocyanate, 1,5-naphthalene diisocyanate, xylylene diisocyanate (XDI), hydrogenated XDI, or tetramethylxylene diisocyanate (TMXDI), an alicyclic polyisocyanate such as cyclohexane-1,4-diisocyanate, isophorone diisocyanate, dicyclohexylmethane-4,4′-diisocyanate, or methylcyclohexane diisocyanate, and an alkylene-based isocyanate such as butane-1,4-diisocyanate, hexamethylene diisocyanate, isopropylene diisocyanate, methylene diisocyanate, or lysine diisocyanate, and as trifunctional or higher polyisocyanates, 1-methylbenzene-2,4,6-triisocyanate, 1,3,5-trimethylbenzene-2,4,6-triisocyanate, biphenyl-2,4,4′-triisocyanate, diphenylmethane-2,4,4′-triisocyanate, methyldiphenylmethane-4,6,4′-triisocyanate, 4,4′-dimethyldiphenylmethane-2,2′,5,5′tetraisocyanate, triphenylmethane-4,4′,4″-triisocyanate, polymeric MDI, lysine ester triisocyanate, 1,3,6-hexamethylene triisocyanate, 1,6,11-undecane triisocyanate, bicycloheptane triisocyanate, 1,8-diisocyanatomethyloctane, and a modified product and derivative thereof.

### 1-1-2. Additives

### 1-1-2-1. Hydrophilicity Imparting Agent

The hydrophilicity imparting agent is not particularly limited as long as it is a component for imparting hydrophilicity to the polyurethane prepolymer or the moisture-curable one-component adhesive composition. Examples of the hydrophilicity imparting agent include a compound having one or more hydrophilic groups in one molecule, and examples of the hydrophilic group include a hydroxyl group, a carboxyl group, an amino group, a sulfone group, and a polyoxyethylene group.

The hydrophilicity imparting agent is considered to impart hydrophilicity to an adhesive that is incompatible with a polyurethane portion which is a skeleton of a moisture-curable hot melt adhesive, is oriented on a surface, and is solidified and reacted in a solidifying and reacting process of the moisture-curable one-component adhesive composition. Among these hydrophilicity imparting agents, a hydrophilicity imparting agent which is a nonionic compound (nonionic surfactant) not containing a hydroxyl group, a carboxyl group, a sulfonyl group, an amino group, an epoxy group, and an acid anhydride of a carboxyl group or a sulfonyl group is preferable, a hydrophilicity imparting agent having a polyoxyethylene group is more preferable, a hydrophilicity imparting agent selected from the group consisting of polyoxyethylene fatty acid ester, fatty acid ester alkoxylate, and polyethylene glycol dialkyl ether is still more preferable, and a hydrophilicity imparting agent, which is a compound represented by any one of the following Formulas (1) to (4), in which R₁, R₂, R₃, R₄, and R₅ are alkyl chains having 8 or more carbon atoms, R₆, R₇, and R₈ are alkyl chains having 20 or fewer carbon atoms, R₉ is an alkyl chain having 20 or fewer carbon atoms, and R₁ to R₉ do not contain an active hydrogen group such as a hydroxyl group or an amino acid, and a functional group that can react with an isocyanate group (a carboxylic acid, an acid anhydride, or an epoxy group) is most preferable.

### [Chem. 1]

### 1-1-2-2. Others

The polyurethane prepolymer or the moisture-curable one-component adhesive composition can contain various additives, if necessary, in addition to the above-described components as long as the object of the present invention is not impaired. Examples of the additives include a filler, a plasticizer, a pigment, a dye, an antiaging agent, an antioxidant, an antistatic agent, a flame retardant, a tackifier, an antibacterial agent, a light stabilizer, a stabilizer, a dispersant, and a solvent.

In the moisture-curable one-component adhesive composition of the present embodiment, a contact angle obtained under the following contact angle evaluation conditions is preferably 60° or less, more preferably 55° or less, still more preferably 50° or less, and particularly preferably 45° or less.

### (Contact Angle Evaluation Conditions)

The moisture-curable one-component adhesive composition is applied onto a glass plate (preparation) and left to stand for 24 hours, and a contact angle between a cured resin and water is measured in accordance with JIS K6798:1999.

According to this, the absorbency of the moisture-curable one-component adhesive composition can be further enhanced.

The moisture-curable one-component adhesive composition described above has an excellent balance of both absorbency and adhesive strength.

### 2. Method for Preparing Moisture-Curable One-Component Adhesive Composition

A method for preparing a moisture-curable one-component adhesive composition may be any known method, and is not particularly limited as long as the prepared moisture-curable one-component adhesive composition does not impair the object of the present invention. Examples thereof include a method for preparing a moisture-curable one-component adhesive composition by (1) adding a predetermined amount of a polyol dropwise to a reaction vessel containing a predetermined amount of a polyisocyanate and then performing heating to allow a reaction to proceed under a condition in which an isocyanate group of the polyisocyanate is excessive with respect to a hydroxyl group of the polyol so as to prepare a polyurethane prepolymer; and (2) adding a predetermined amount of a hydrophilicity imparting agent dropwise to the polyurethane prepolymer and performing stirring. The reaction is usually performed at a temperature of 50 to 120° C. and preferably 60 to 100° C. A reaction time is usually 1 to 15 hours.

More preferred examples of the preparation method include a method for preparing a moisture-curable one-component adhesive composition by (1) adding a part of a hydrophilicity imparting agent (2 to 10 mass % of the hydrophilicity imparting agent with respect to the total weight of the moisture-curable one-component adhesive composition) dropwise, in terms of blending amount, to a reaction vessel containing a predetermined amount of a polyisocyanate and performing mixing, and then adding a predetermined amount of crystalline polyol (Aa) and amorphous polyol (Ab) (hereinafter, simply referred to as a polyol) dropwise thereto and performing heating to allow a reaction to proceed under a condition in which an isocyanate group of the polyisocyanate is excessive with respect to a hydroxyl group of the polyol so as to prepare a polyurethane prepolymer; and (2) adding the remaining hydrophilicity imparting agent dropwise to the polyurethane prepolymer and performing stirring. This makes it possible to uniformly disperse the hydrophilicity imparting agent in the polyurethane prepolymer. In addition, the reaction is usually performed at a temperature of 50 to 120° C. and preferably 70 to 95° C. A reaction time is usually 1 to 15 hours.

In the blending of the polyol and the polyisocyanate used in the preparation of the polyurethane prepolymer, an equivalent ratio of the isocyanate group of the polyisocyanate to the hydroxyl group of the polyol (hereinafter, referred to as an equivalent ratio of [isocyanate group/hydroxyl group]) is preferably in a range of 1.1 to 1.2, and more preferably in a range of 1.2 to 1.5.

The polyurethane prepolymer can be usually prepared in the absence of a solvent, and may be prepared by reacting a polyol and a polyisocyanate in an organic solvent. When the reaction is performed in an organic solvent, an organic solvent that does not inhibit the reaction, such as ethyl acetate, n-butyl acetate, methyl ethyl ketone, or toluene, can be used, but it is necessary to remove the organic solvent by a method such as heating under reduced pressure in the middle of the reaction or after completion of the reaction.

When the polyurethane prepolymer is prepared, a urethanization catalyst can be used, if necessary. The urethanization catalyst can be appropriately added at any stage of the reaction. As the urethanization catalyst, for example, a nitrogen-containing compound such as triethylamine, triethylenediamine, or N-methylmorpholine; a metal salt such as zinc stearate or tin octylate; and an organometallic compound such as dibutyltin dilaurate can be used.

A number average molecular weight of the polyurethane prepolymer obtained by the above method is preferably in a range of 1,000 to 50,000 and more preferably in a range of 3,000 to 10,000 in order to achieve both absorbency and adhesive strength. Note that the number average molecular weight can be a numerical value measured by gel permeation chromatography and converted as a molecular weight of polystyrene, which is a standard sample.

An NCO group content of the isocyanate-terminated polyurethane prepolymer is preferably 0.01 to 10 mass %, more preferably 0.3 to 5.0 mass %, and still more preferably 1.0 to 3.0 mass %. According to this, it possible to achieve both absorbency and adhesive strength. Note that the NCO group content can be measured according to JIS K1603-2007.

A urethane group concentration (mol/Kg) of the isocyanate-terminated polyurethane prepolymer is preferably 0.01 to 1.0 mol/Kg, more preferably 0.02 to 0.5 mol/Kg, and still more preferably 0.03 to 0.3 mol/Kg. According to this, an excellent balance of absorbency and adhesive strength can be exhibited.

### 3. Applications of Moisture-Curable One-Component Adhesive

A moisture-curable one-component adhesive according to the present embodiment is preferable for applications such as an adhesive, a sealant, a primer, a paint, and a coating agent, and is more preferable as an adhesive used for an adherend requiring hydrophilicity. In particular, the moisture-curable one-component adhesive is suitable for bonding adherends that need to rapidly absorb water, such as disposable diapers and sanitary napkins. The adherend is an absorber that separates and absorbs a liquid or the like having an appropriate viscosity. For example, in a disposable diaper, the absorber is configured by laminating a top sheet that is a liquid permeable layer on one surface thereof, and a liquid leakage preventing sheet, a waterproof back sheet, or the like on an opposite surface thereof, as an intermediate layer. The moisture-curable one-component adhesive is applied to an interface between the top sheet and the intermediate layer and/or an interface between the liquid leakage preventing sheet and the intermediate layer. Note that the intermediate layer is provided in a pattern of, for example, a dot shape, a spiral shape, a stripe shape, a fiber shape, or the like so as to permeate water.

The moisture-curable one-component adhesive according to the present embodiment can be applied by a known method by heating and melting. For example, the coating can be performed using a brush, a spatula, a syringe, a sealing gun, a dispenser, a spray, or the like. Among them, application by spraying is a more preferred use method for obtaining a water-permeable adhesive interface. In this case, in order to make application by spraying suitable, as a viscosity of the moisture-curable one-component adhesive composition, a melt viscosity at 120° C. is preferably 40,000 mPa s or less, more preferably 30,000 mPa s or less, and still more preferably 20,000 mPa s or less for securing both absorbency and adhesive strength. Note that the melt viscosity at 120° C. can be measured with a B-type viscometer in accordance with JIS Z8803-2011.

After being applied, the moisture-curable one-component adhesive is solidified by cooling, and thereafter, moisture in the atmosphere or the like and the isocyanate group react with each other, and the moisture-curable one-component adhesive is crosslinked to be cured and bonded.

Although the embodiments of the present invention have been described above, these are examples of the present invention, and various configurations other than the above can be adopted.

### Examples

Hereinafter, the present invention will be described with reference to Examples and Comparative Examples, but the present invention is not limited thereto.

Polyols used for preparing a moisture-curable one-component adhesive composition are as follows.

### (Crystalline Polyol)

Polyester polyol composed of adipic acid-1,4-butanediol (number average molecular weight: 2,000)
Polyester polyol composed of adipic acid-1,6-hexanediol (number average molecular weight: 2,000)
Polyester polyol composed of sebacic acid-1,6-hexanediol (number average molecular weight: 2,000)

### (Amorphous Polyol)

Polyester polyol composed of adipic acid-diethylene glycol (number average molecular weight: 2,000)
Polyester polyol composed of adipic acid-diethylene glycol (number average molecular weight: 1,000)
Polyester polyol composed of phthalic acid-diethylene glycol (number average molecular weight: 2,000)
Polyester polyol composed of phthalic acid-diethylene glycol (number average molecular weight: 1,000)
Polyester polyol composed of phthalic acid-diethylene glycol (number average molecular weight: 500)
Polyester polyol composed of phthalic acid-methylpropanediol (number average molecular weight: 1,000)
Polyester polyol composed of phthalic acid-neopentyl glycol (number average molecular weight: 1,000)
Polyester polyol composed of phthalic acid-1,4-cyclohexanedimethanol (number average molecular weight: 1,000)

Whether each of the above-described polyols was crystalline or amorphous was confirmed by the following method.

### <<Apparatus Used and the Like>>

Apparatus used: DSC7020, manufactured by Hitachi, Ltd.
Sample pan: formed of aluminum (blank, for sample filling)

### <<Procedure>>

(1) A predetermined amount of a polyol is weighed on an aluminum pan.
(2) An empty aluminum pan (blank) and an aluminum pan filled with a polyol (test specimen) are placed at predetermined positions in the DSC apparatus.
(3) Measurement is performed under the following measurement program and measurement conditions.

### <Measurement (Temperature Condition) Program>

“Room temperature (25° C.)”, “cooling to −80° C., holding at −80° C. (5 minutes)”, “heating to 150° C.”, “holding at 150° C. (for 5 minutes)”, “cooling to −80° C.”, “holding at −80° C. (measurement is completed after holding for 5 minutes)”, “returning to room temperature”

### <Measurement Conditions>

Sample amount: 10 mg±0.5 mg
Temperature range: −80° C. to 150° C. (gas flow rate: 100 mL/min under nitrogen atmosphere)
Heating/cooling rate: 5° C./min
Refrigerant (used in cooling step): liquid nitrogen
(4) The presence or absence of a melting peak (heating process, negative peak) and a crystallization peak (cooling process, positive peak) resulting from a melting point in the obtained DSC curve is confirmed.
(5) When both the melting peak and the crystallization peak are confirmed, the polyol is determined to have crystallinity. On the other hand, when at least one of the melting peak and the crystallization peak is not confirmed, the polyol is determined to be amorphous.

### (Preparation of Moisture-Curable One-Component Adhesive Composition)

A method for preparing a moisture-curable one-component adhesive composition of each of Examples 1 to 16 and Comparative Examples 1 and 2 is shown. Note that a blending amount of each of the compositions is shown in Table 1. A predetermined amount of an isocyanate shown in Table 1 was placed in a reaction vessel, a predetermined amount of a polyol was added dropwise, the mixture was then heated to 60° C. and reacted for 5 hours, a predetermined amount of a hydrophilicity imparting agent was then added, and the mixture was stirred, thereby preparing a composition.

### (Evaluation Method)

The measurement results by the following evaluation method are shown in Table 1.

### <Urethane Group Concentration>

A urethane group concentration (mol/Kg) of the polyurethane prepolymer contained in each of the prepared moisture-curable one-component adhesive compositions was calculated by the following method. When the mass of the urethane prepolymer is 1 kg for all the polyol compounds to be raw materials of the urethane prepolymer and all the polyisocyanate compounds, the blending amounts (mass) of each polyol compound and each polyisocyanate compound are determined so that NCO % of the urethane prepolymer has a desired value. The blending amount (mass) of each polyol compound is divided by the molecular weight of each polyol compound, the number of functional groups of each polyol compound is further multiplied to calculate the number of moles of the hydroxyl groups contained in all the polyol compounds, and the number of moles of the hydroxyl groups is defined as the urethane group concentration (mol/Kg) of the urethane prepolymer, which is obtained by reacting all the hydroxyl groups with the isocyanate groups of the polyisocyanate compound to form a urethane bond.

### <NCO % of Prepolymer>

An NCO group content of the polyurethane prepolymer contained in each of the prepared moisture-curable one-component adhesive compositions was measured according to Method A/Dibutylamine hydrochloric acid method of JIS K1603-2007. The measurement conditions of the NCO group content are as follows.
Sample amount: 10±2 g
Dibutylamine toluene solution: 0.1 mol/L
Hydrochloric acid concentration: 0.1 mol/L
Indicator: bromophenol blue (discoloration point: purple to yellow)

### <Melt Viscosity>

A melt viscosity of each of the prepared moisture-curable one-component adhesive compositions was measured using a rheometer (“MCR-302”, manufactured by Anton Paar GmbH). The measurement conditions of the melt viscosity are as follows.
Measurement temperature: 120° C.
Strain: 5 to 20% ( 1/12 second interval)
Angular frequency: 0.1 to 100 rad/sec ( 1/12 sec interval)
Use of parallel plate

### <First Normal Stress Difference>

A first normal stress difference of each of the prepared moisture-curable one-component adhesive compositions was measured simultaneously with the measurement of the melt viscosity using a rheometer (“MCR-302”, manufactured by Anton Paar GmbH). The measurement conditions of the first normal stress difference are as follows.
Measurement temperature: 120° C.
Strain: 5 to 20% ( 1/12 second interval)
Angular frequency: 0.1 to 100 rad/sec ( 1/12 sec interval)
Use of parallel plate

The “first normal stress difference” is a parameter indicating a viscosity of a polymer (resin) liquid. When shear deformation is applied to the polymer (resin) liquid, normal stress (tension) is generated in a flow direction. The “first normal stress difference” is a parameter used as a measure of the normal stress. The definition is a difference between the normal stress in the flow direction and the normal stress in the velocity gradient direction. When the “first normal stress difference” increases, the melt tension increases and tends to be fibrous, such that fibers are formed between substrates (foam/nonwoven fabric), and absorbency and liquid diffusibility are improved by capillary phenomenon. From this viewpoint, a lower limit of the first normal stress difference of each of the prepared moisture-curable one-component adhesive compositions is preferably 1,000 mPa or more, more preferably 2,000 mPa or more, and still more preferably 3,000 mPa or more. On the other hand, an upper limit of the first normal stress difference is preferably 10,000 mPa or less, more preferably 8,000 mPa or less, and still more preferably 6,000 mPa or less.

### <Fiber Retention Time>

Each of the prepared moisture-curable one-component adhesive compositions was heated to 120° C. and applied onto a substrate (size: 100 mm×100 mm, material: polypropylene (PP) nonwoven fabric) using an application apparatus under the following application conditions to prepare a measurement sample.

### Application Conditions

Applied amount: 10 g/m²
Heating temperature: 120° C.
Nozzle diameter: 1 mm
Discharge pressure: 0.01 MPa
Application environmental temperature: 25° C.

While the structure of the obtained measurement sample was observed using a microscope, the time during which the fibrous structure was retained (the time from the application to the collapse of the fibrous structure) was measured with a stopwatch and defined as a fiber retention time. A fiber retention time of 5 minutes or longer was rated as 2 points, a fiber retention time of 2 minutes or longer and shorter than 5 minutes was rated as 1 point, and a fiber retention time of shorter than 2 minutes was rated as 0 points. Note that the “fiber retention time” represents the maximum time during which the moisture-curable one-component adhesive composition can retain the fiber shape on the surface of the substrate after the moisture-curable one-component adhesive composition is applied. As the time is longer, the fiber shape can be retained, and the fiber shape can be retained even after the substrate is bonded. On the other hand, when the time is short, the fiber shape cannot be retained on the surface of the substrate, and the fibers are formed into droplets or aggregates, which makes it difficult to use the substrate in applications requiring fibrous coating such as disposable diapers.

### <Contact Angle>

Each of the prepared moisture-curable one-component adhesive compositions was applied onto a glass preparation, left to stand for 24 hours, and completely cured to obtain a sample for evaluation. A contact angle of the sample for evaluation with respect to water was measured using a contact angle meter (CA-D, manufactured by Kyowa Interface Science Co., Ltd.). Note that the measurement method was in accordance with JIS K6768:1999. A contact angle of 340 or less was rated as 3 points, a contact angle of more than 34° and 60° or less was rated as 1 point, and a contact angle of more than 60° was rated as 0 points.

### <Initial Adhesive Strength>

Each of the prepared moisture-curable one-component adhesive compositions was heated to 120° C. and applied onto a substrate (material: polypropylene (PP) nonwoven fabric) using an application apparatus under the following application conditions, and then the urethane foam and the PP nonwoven fabric were bonded to each other via a coating film to prepare a measurement sample.

### Application Conditions

Applied amount: 10 g/m²
Heating temperature: 120° C.
Nozzle diameter: 1 mm
Discharge pressure: 0.01 MPa
Application environmental temperature: 25° C.
Substrate dimension: width 25 mm×length 200 mm (applied portion: width 25 mm×150 mm, gripping margin: each 25 mm at both ends)

One end of the urethane foam of the measurement sample was sandwiched between clips and fixed to a force gauge (IMADA Co., Ltd., digital force gauge, maximum load: 500 N) via a hook-shaped probe. After 30 seconds from the bonding, the nonwoven fabric was peeled off at an angle of 180°, and the peel strength at this time was taken as the initial adhesive strength.

The case where the initial adhesive strength was 50 cN or more was rated as 2 points, the case where the initial adhesive strength was 41 cN or more and less than 50 cN was rated as 1 point, and the case where the initial adhesive strength was less than 41 cN was rated as 0 points.

### <Final Adhesive Strength>

The final adhesive strength of each of the prepared moisture-curable one-component adhesive compositions was measured using a material testing machine (Tensilon RAC-1150A, manufactured by A&D Company, Limited) in accordance with JIS K6854-3:1999. As a sample for measurement, a polypropylene nonwoven fabric having a length of 100 mm×a width of 25 mm×a thickness of 100 μm was spray-coated with the adhesive composition at a width of 25 mm (application temperature: 120° C., application amount: 10 g/m²), a cotton fabric having the same size was bonded to the polypropylene nonwoven fabric, and the resultant was left to stand in an atmosphere at 25° C. for 24 hours. The case where the final adhesive strength was 1.5 N or more was rated as 2 points, the case where the final adhesive strength was 1.0 N or more and less than 1.5 N was rated as 1 point, and the case where the final adhesive strength was less than 1.0 N was rated as 0 points.

### <Melt Tack>

The moisture-curable one-component adhesive composition was melted at 120° C. After the moisture-curable one-component adhesive composition was completely melted, a film having a thickness of 50 μm was formed using a bar coater. When the surface of the melt constituting the film reached 80±2° C., tack of the moisture-curable one-component adhesive composition in a molten state was measured using a force gauge equipped with a disk-shaped probe. Note that the “melt tack” is an index of the stickiness (tackiness) of the moisture-curable one-component adhesive composition in a molten state. The moisture-curable one-component adhesive composition before application is a heated and melted liquid, and is in a liquid state even immediately after application by spraying or the like. When the tackiness in a liquid state is strong, after the moisture-curable one-component adhesive composition is applied and the substrates are bonded to each other, the substrates are less likely to be peeled from each other (temporary fixing). On the other hand, when the melt tack is low, after the substrates are bonded to each other with the moisture-curable one-component adhesive composition interposed therebetween, peeling of the substrates is likely to occur, and product defects are likely to occur in the production process.

### <Tack Free Time>

The moisture-curable one-component adhesive composition was melted at 120° C. After the moisture-curable one-component adhesive composition was completely melted, a film having a thickness of 300 μm was formed using a bar coater. For the obtained film, the time until the tack disappeared was measured by finger touch, and the obtained time was taken as a tack free time. The “tack free time” is the maximum time during which the tackiness can be maintained after the moisture-curable one-component adhesive composition is applied. By prolonging the tack free time, tackiness can be obtained even at a temperature lower than the coating temperature, such that it is possible to prevent peeling after bonding the substrates.

### <Sprayability>

The moisture-curable one-component adhesive composition melted at 120° C. was applied to a PET film having a size of 210 mm×297 mm (A4 size) at 10 g/m², the shape after the application was confirmed with a microscope, and the sprayability was determined according to the following criteria.

### <<Criterion>>

Uniformly applied in fibrous form: 2 points
Appearance of some aggregates: 1 point
Applied in no fibrous form: 0 points

<Absorption Rate>

Each of the prepared moisture-curable one-component adhesive compositions was applied in a spray form to the entire surface of a urethane foam having a size of 100 mm×100 mm×5 mmt (application temperature: 120° C., application amount: 10 g/m², nozzle diameter: 1 mm, discharge pressure: 0.01 Pa), a polypropylene nonwoven fabric having a size of 100 mm×100 mm×100 μm was superimposed thereon, the resulting laminate was left to stand in an atmosphere at 25° C. for 24 hours to completely bond the substrates to each other, and the resulting laminate was used as a measurement sample.

The nonwoven fabric of the measurement sample was set as an upper surface, and a cylindrical tube having an inner diameter of 50 mm was fixed perpendicularly to the surface of the nonwoven fabric of the sample. 20 mL of water colored with a blue ink was weighed and poured into the cylindrical tube, and the time until the colored water was completely absorbed into the test sample from above the cylindrical tube (until the colored water became invisible from the surface of the nonwoven fabric) was measured. Note that the case where the absorption time was 15 seconds or shorter was evaluated as 3 points, the case where the absorption time was longer than 15 seconds and shorter than 20 seconds was evaluated as 1 point, and the case where the absorption time was 20 seconds or longer was evaluated as 0 points.

### <Diffusion Area>

Each of the prepared moisture-curable one-component adhesive compositions was applied in a spray form to the entire surface of a urethane foam having a size of 100 mm×100 mm×5 mmt (application temperature: 120° C., application amount: 10 g/m², nozzle diameter: 1 mm, discharge pressure: 0.01 Pa), a polypropylene nonwoven fabric having a size of 100 mm×100 mm×100 μm was superimposed thereon, the resulting laminate was left to stand in an atmosphere at 25° C. for 24 hours to completely bond the substrates to each other, and the resulting laminate was used as a measurement sample. The nonwoven fabric of the measurement sample was set as an upper surface, and a cylindrical tube having an inner diameter of 50 mm was fixed perpendicularly to the surface of the nonwoven fabric of the sample. 20 mL of water colored with a blue ink was weighed and poured into the cylindrical tube, and after the colored water was completely absorbed into the test sample from above the cylindrical tube, in order to measure an area of the portion where the nonwoven fabric dyed blue, a still image was taken, and then the image was read and measured with image analysis software (product name: Image-Pro 6.2, Hakuto Co., Ltd.). Note that the case where the diffusion area was 50 cm² or more was rated as 3 points, the case where the diffusion area was 41 cm² or more and less than 50 cm² was rated as 1 point, and the case where the diffusion area was less than 41 cm² was rated as 0 points.

### <Comprehensive Evaluation>

The total of the evaluation points was calculated, and then, a total point of 14 points or more was rated as A (excellent), a total point of 10 to 13 points was rated as B (good), and a total point of 9 points or less was rated as C (poor).

TABLE 1

pbw

| Configuration | | Composition | Example 1 | Example2 | Example 3 | Example4 | Example5 |
|---|---|---|---|---|---|---|---|
| Polyol | Crystalline | Raw material [symbol] molecular weight 2,000 | 28.4 | 29.4 | 28.4 | 30.7 | 29.8 |
| | | Raw material [symbol] molecular weight 2,000 | | | | | |
| | Amorphous 1 | Raw material [symbol] molecular weight 2,000 | | | | | |
| | | Raw material [symbol] molecular weight 1,000 | 33.6 | 33.8 | 33.6 | 35.1 | 34.0 |
| | Amorphous 2 | Raw material [symbol] molecular weight 1,000 | 21.0 | | | | 21.3 |
| | | Raw material [symbol] molecular weight 500 | | | | | |
| | | Raw material [symbol] molecular weight 1,000 | | 21.0 | | 17.5 | |
| | | Raw material [symbol] molecular weight 1,000 | | | 21.0 | 4.2 | |

| Isocyanate | Monomeric MDI (2.4-/4.4-ratio: 80/20) | 16.0 | 18.0 | 16.0 | 18.7 | 14.9 |
|---|---|---|---|---|---|---|
| Total | | 100.0 | 100.0 | 100.0 | 104.2 | 100.0 |
| Hydrophilicity | Polyoxyethylene dioleate | 7.5 | 7.5 | 7.5 | 7.8 | 7.5 |
| imparting agent | Polyoxyethylene stearic acid triglyceride | | | | | |
| | Polyoxyethylene dodecylic acid methyl ether | | | | | |
| | Polyoxyethylene diethyl ether | | | | | |

| Total | | | 107.5 | 107.5 | 107.5 | 112.0 | 107.5 |
|---|---|---|---|---|---|---|---|
| Physical | Urethane group concentration | | 0.10 | 0.10 | 0.10 | 0.10 | 0.15 |
| properties | NCO % of Prepolymer | | 1.80 | 1.80 | 1.80 | 1.80 | 1.20 |
| | Melt viscosity | mPa · s/120° C. | 17,800 | 16,200 | 18,200 | 25,400 | 24,800 |
| | First normal stress difference | mPa/120° C. | 2,230 | 2,280 | 2,320 | 3,380 | 3,140 |
| | Fiber retention time | Minute | 8 | 7 | 7 | 8 | 15 |
| | | Point | 2 | 2 | 2 | 2 | 2 |
| | Contact angle | Degree | 50 | 55 | 50 | 45 | 30 |
| | | Point | 3 | 1 | 1 | 1 | 2 |
| | Initial adhesive | cN/25 mm | 60 | 53 | 43 | 55 | 60 |
| | strength | Point | 2 | 2 | 1 | 2 | 2 |
| | Final adhesive | N/25 mm | 1.80 | 1.57 | 1.82 | 1.66 | 1.78 |
| | strength | Point | 2 | 2 | 2 | 2 | 2 |
| | Melt tack(80° C.) | N | 7.10 | 7.43 | 8.28 | 7.32 | 8.20 |
| | Tack free time | Minute | 22 | 19 | 20 | 25 | 18 |
| | Sprayability(120° C.) | | 2 | 2 | 2 | 2 | 1 |
| | Absorption rate | Second | 10 | 15 | 14 | 13 | 12 |
| | | Point | 3 | 3 | 2 | 3 | 3 |
| | Diffusion area | cm³ | 68 | 53 | 54 | 60 | 80 |

| | Point | 3 | 3 | 3 | 3 | 3 |
|---|---|---|---|---|---|---|
| Comprehensive evaluation | Point | 17 | 15 | 14 | 15 | 15 |
| | Determination | A | A | A | A | A |

| | | | pbw | | | | |
|---|---|---|---|---|---|---|---|
| Configuration | | Composition | Example6 | Example7 | Example8 | Example9 | Example10 |
| Polyol | Crystalline | Raw material [symbol] molecular weight 2,000 | 28.0 | 29.6 | 28.4 | 0.0 | 29.4 |
| | | Raw material [symbol] molecular weight 2,000 | | | | 29.4 | |
| | Amorphous 1 | Raw material [symbol] molecular weight 2,000 | | 33.8 | | | |
| | | Raw material [symbol] molecular weight 1,000 | 33.2 | | 33.6 | 33.6 | 33.6 |
| | Amorphous 2 | Raw material [symbol] molecular weight 1,000 | 20.7 | 21.1 | | 21.0 | 21.0 |
| | | Raw material [symbol] molecular weight 500 | | | 21.0 | | |
| | | Raw material [symbol] molecular weight 1,000 | | | | | |
| | | Raw material [symbol] molecular weight 1,000 | | | | | |

| Isocyanate | Monomeric MDI (2.4-/4.4-ratio: 80/20) | 17.0 | 15.5 | 16.0 | 18.0 | 16.0 |
|---|---|---|---|---|---|---|
| Total | | 100.0 | 100.0 | 100.0 | 100.0 | 100.0 |
| Hydrophilicity | Polyoxyethylene dioleate | 7.5 | 7.5 | 7.5 | 7.5 | 5.0 |
| imparting agent | Polyoxyethylene stearic acid triglyceride | | | | | |
| | Polyoxyethylene dodecylic acid methyl ether | | | | | |
| | Polyoxyethylene diethyl ether | | | | | |

| Total | | | 107.5 | 107.5 | 107.5 | 107.5 | 105.0 |
|---|---|---|---|---|---|---|---|
| Physical | Urethane group concentration | | 0.03 | 0.08 | 0.13 | 0.10 | 0.10 |
| properties | NCO % of Prepolymer | | 2.40 | 1.50 | 1.80 | 1.80 | 1.80 |
| | Melt viscosity | mPa · s/120° C. | 12,600 | 14,800 | 64,000 | 13100 | 21,500 |
| | First normal stress difference | mPa/120° C. | 1,890 | 2,280 | 4,630 | 2,050 | 1,640 |
| | Fiber retention time | Minute | 4 | 4 | 10 | >20 | 5 |
| | | Point | 4 | 1 | 2 | 2 | 2 |
| | Contact angle | Degree | 40 | 30 | 35 | 45 | 50 |
| | | Point | 1 | 3 | 1 | 1 | 1 |
| | Initial adhesive | cN/25 mm | 45 | 45 | 56 | 62 | 64 |
| | strength | Point | 1 | 1 | 2 | 2 | 2 |
| | Final adhesive | N/25 mm | 1.55 | 1.32 | 1.34 | 2.23 | 2.02 |
| | strength | Point | 2 | 1 | 1 | 2 | 2 |
| | Melt tack(80° C.) | N | 4.04 | 5.63 | 7.82 | 6.43 | 7.03 |
| | Tack free time | Minute | 30 | 30 | 20 | 13 | 10 |
| | Sprayability(120° C.) | | 2 | 2 | 1 | 2 | 2 |
| | Absorption rate | Second | 17 | 10 | 10 | 15 | 11 |
| | | Point | 1 | 3 | 3 | 3 | 3 |
| | Diffusion area | cm³ | 53 | 60 | 71 | 52 | 50 |

| | Point | 3 | 3 | 2 | 5 | 3 |
|---|---|---|---|---|---|---|
| Comprehensive evaluation | Point | 11 | 14 | 13 | 15 | 15 |
| | Determination | B | A | B | A | A |

| | | | pbw | | | |
|---|---|---|---|---|---|---|
| Configuration | | Composition | Example11 | Example12 | Example13 | Example14 |
| Polyol | Crystalline | Raw material [symbol] molecular weight 2,000 | 29.4 | 29.4 | 29.4 | 29.4 |
| | | Raw material [symbol] molecular weight 2,000 | | | | |
| | Amorphous 1 | Raw material [symbol] molecular weight 2,000 | | | | |
| | | Raw material [symbol] molecular weight 1,000 | 33.6 | 33.8 | 33.6 | 33.6 |
| | Amorphous 2 | Raw material [symbol] molecular weight 1,000 | 21.0 | 21.0 | 21.0 | 21.0 |
| | | Raw material [symbol] molecular weight 500 | | | | |
| | | Raw material [symbol] molecular weight 1,000 | | | | |
| | | Raw material [symbol] molecular weight 1,000 | | | | |

| Isocyanate | Monomeric MDI (2.4-/4.4-ratio: 80/20) | 16.0 | 16.0 | 16.0 | 16.0 |
|---|---|---|---|---|---|
| Total | | 100.0 | 100.0 | 100.0 | 100.0 |
| Hydrophilicity | Polyoxyethylene dioleate | 10.0 | | | |
| imparting agent | Polyoxyethylene stearic acid triglyceride | | 7.5 | | |

| | | |
|---|---|---|
| Polyoxyethylene dodecylic acid methyl ether | 7.5 | |
| Polyoxyethylene diethyl ether | | 7.5 |

| Total | | 110.0 | 107.5 | 107.5 | 107.5 |
|---|---|---|---|---|---|
| Physical | Urethane group concentration | 0.10 | 0.10 | 0.10 | 0.10 |
| properties | NCO % of Prepolymer | 1.80 | 1.80 | 1.80 | 1.80 |

| Melt viscosity | mPa · s/120° C. | 15,600 | 18,300 | 15,200 | 11,800 |
|---|---|---|---|---|---|
| First normal stress difference | mPa/120° C. | 1,950 | 2,400 | 2,070 | 2,020 |
| Fiber retention time | Minute | 5 | 8 | 6 | 5 |
| | Point | 2 | 2 | 2 | 2 |
| Contact angle | Degree | 25 | 35 | 30 | 45 |
| | Point | 2 | 1 | 3 | 1 |
| Initial adhesive | cN/25 mm | 46 | 57 | 55 | 46 |
| strength | Point | 1 | 2 | 2 | 1 |
| Final adhesive | N/25 mm | 1.45 | 1.80 | 1.71 | 1.63 |
| strength | Point | 1 | 2 | 2 | 2 |
| Melt tack(80° C.) | N | 6.33 | 6.88 | 6.45 | 6.51 |
| Tack free time | Minute | 27 | 20 | 18 | 16 |
| Sprayability(120° C.) | | 2 | 2 | 2 | 2 |
| Absorption rate | Second | 10 | 12 | 10 | 12 |
| | Point | 3 | 3 | 3 | 3 |
| Diffusion area | cm³ | 70 | 60 | 55 | 63 |

| | Point | 3 | 3 | 3 | 3 |
|---|---|---|---|---|---|
| Comprehensive evaluation | Point | 15 | 15 | 17 | 14 |

| | | | | |
|---|---|---|---|---|
| Determination | A | A | A | A |

| | | | | | pbw | |
|---|---|---|---|---|---|---|
| | | | pbw | | Comparative | Comparative |
| Configuration | | Composition | Example15 | Example16 | Example 1 | Example 2 |
| Polyol | Crystalline | Raw material [symbol] molecular weight 2,000 | 29.4 | 29.4 | 0.0 | 84.2 |
| | | Raw material [symbol] molecular weight 2,000 | | | | |
| | Amorphous 1 | Raw material [symbol] molecular weight 2,000 | | | | |
| | | Raw material [symbol] molecular weight 1,000 | | 54.8 | 63.0 | 0.0 |
| | Amorphous 2 | Raw material [symbol] molecular weight 1,000 | 54.6 | | 21.0 | |
| | | Raw material [symbol] molecular weight 500 | | | | |
| | | Raw material [symbol] molecular weight 1,000 | | | | |
| | | Raw material [symbol] molecular weight 1,000 | | | | |

| Isocyanate | Monomeric MDI (2.4-/4.4-ratio: 80/20) | 16.0 | 16.0 | 16.0 | 15.6 |
|---|---|---|---|---|---|
| Total | | 100.0 | 100.0 | 100.0 | 100.0 |
| Hydrophilicity | Polyoxyethylene dioleate | 7.5 | 7.5 | 7.5 | |
| imparting agent | Polyoxyethylene stearic acid triglyceride | | | | |

| | |
|---|---|
| Polyoxyethylene dodecylic acid methyl ether | |
| Polyoxyethylene diethyl ether | 0.5 |

| Total | | 107.5 | 107.5 | 107.5 | 105.3 |
|---|---|---|---|---|---|
| Physical | Urethane group concentration | 0.12 | 0.15 | 0.10 | 0.10 |
| properties | NCO % of Prepolymer | 1.80 | 1.80 | 1.88 | 1.81 |

| Melt viscosity | mPa · s/120° C. | 30,000 | 15,800 | 16,600 | 12,300 |
|---|---|---|---|---|---|
| First normal stress difference | mPa/120° C. | 3,040 | 3,120 | 1,970 | 540 |
| Fiber retention time | Minute | >20 | 2 | 2 | 0.5 |
| | Point | 2 | 1 | 1 | 0 |
| Contact angle | Degree | 55 | 20 | 25 | 39 |
| | Point | 1 | 5 | 3 | 1 |
| Initial adhesive | cN/25 mm | 61 | 13 | 31 | 20 |
| strength | Point | 2 | 0 | 0 | 0 |
| Final adhesive | N/25 mm | 1.22 | 1.05 | 0.87 | 2.80 |
| strength | Point | 1 | 1 | 0 | 2 |
| Melt tack(80° C.) | N | 6.77 | 2.60 | 0.33 | 1.50 |
| Tack free time | Minute | 30 | 35 | 0.5 | 5 |
| Sprayability(120° C.) | | 2 | 2 | 2 | 2 |
| Absorption rate | Second | 16 | 12 | 17 | 2 |
| | Point | 1 | 3 | 1 | 3 |
| Diffusion area | cm³ | 52 | 63 | 48 | 45 |

| | Point | 3 | 3 | 1 | 1 |
|---|---|---|---|---|---|
| Comprehensive evaluation | Point | 12 | 13 | 0 | 9 |

| | | | | |
|---|---|---|---|---|
| Determination | B | B | C | C |

[symbol]

indicates data missing or illegible when filed

As shown in Table 1, it was confirmed that each of the moisture-curable one-component adhesive compositions of Examples 1 to 16 had an excellent absorption rate and an excellent diffusion area, which are indexes regarding absorbency, and had an excellent initial adhesive strength and an excellent final adhesive strength. On the other hand, in Comparative Example 1, the initial adhesive strength and the final adhesive strength were insufficient, and in Comparative Example 2, the initial adhesive strength was insufficient.

### CITATION LIST

### Patent Literature

Patent Literature 1: JP 2000-514108 A
Patent Literature 2: JP 6-316689 A

1. A moisture-curable one-component adhesive composition comprising:
a polyurethane prepolymer (A) obtained by reacting a crystalline polyol (Aa) and an amorphous polyol (Ab) with a polyisocyanate (B); and
a hydrophilicity imparting agent (C),
wherein the moisture-curable one-component adhesive composition satisfies at least one of the following (1) to (4):
(1) a blending amount of the hydrophilicity imparting agent (C) is 2 mass % or more with respect to a total weight of the moisture-curable one-component adhesive composition:
(2) the hydrophilicity imparting agent (C) has a polyoxyethylene group:
(3) the hydrophilicity imparting agent (C) does not have an amino group; and
(4) a contact angle obtained under the following contact angle evaluation conditions is 60° or less,
(Contact angle evaluation conditions)
the moisture-curable one-component adhesive composition is applied onto a glass plate and left to stand for 24 hours, and a contact angle between a cured resin and water is measured in accordance with JIS K6798:1999.

2. (canceled)

3. The moisture-curable one-component adhesive composition according to claim 1, wherein the amorphous polyol (Ab) includes an amorphous polyol (Ab1) having a structural unit derived from an aliphatic dicarboxylic acid and an amorphous polyol (Ab2) having a structural unit derived from an aromatic dicarboxylic acid.
